(19) United States
(12) Patent Application Publication
(10) Pub. No.: US 2024/0282489 A1
(43) Pub. Date: Aug. 22, 2024

(54) CHIP ELECTRONIC COMPONENT

(71) Applicant: Murata Manufacturing Co., Ltd., Nagaokakyo-shi (JP)

(72) Inventors: Masakiyo NAGATOMO, Nagaokakyo-shi (JP); Keisuke ISOGAI, Nagaokakyo-shi (JP); Yoshinobu SAKI, Nagaokakyo-shi (JP)

(21) Appl. No.: 18/652,022

(22) Filed: May 1, 2024

Related U.S. Application Data
(63) Continuation of application No. PCT/JP2022/039723, filed on Oct. 25, 2022.

(30) Foreign Application Priority Data
Dec. 3, 2021 (JP) 2021-197184

(51) Int. Cl. H01C 7/02; H01C 1/142

(52) U.S. Cl. CPC H01C 7/025; H01C 1/142; H01C 7/021

(57) ABSTRACT

A chip electronic component includes a ceramic body that includes a semiconductor ceramic including an oxide including Ti and Ba, and a solid metal electrode at an end of the ceramic body and in ohmic contact with the ceramic body. The chip electronic component satisfies: A/V≥3.3 (mm²/mm³), where A (mm²) is a surface area of the solid metal electrode, and V (mm³) is a volume of the ceramic body, and a film stress of the solid metal electrode is about 140 MPa or more.

### CROSS REFERENCE TO RELATED APPLICATIONS

This application claims the benefit of priority to Japanese Patent Application No. 2021-197184, filed on Dec. 3, 2021, and is a Continuation application of PCT Application No. PCT/JP2022/039723, filed on Oct. 25, 2022. The entire contents of each application are hereby incorporated herein by reference.

### BACKGROUND OF THE INVENTION

### 1. Field of the Invention

The present invention relates to chip electronic components, and particularly relates to chip electronic components including a semiconductor ceramic.

### 2. Description of the Related Art

As ceramics, those exhibiting a piezoresistive phenomenon in which a resistance value changes by applying stress are known. For example, ceramics such as La_{1-X}Sr_{X}MnO₃ and BaTiO₃ have a property (piezoresistive effect) in which the resistance changes according to the magnitude of strain and the magnitude of stress (for example, Japanese Patent No. 4611127). Perovskite-type manganese oxide La_{1-X}Sr_{X}MnO₃ exhibits a relatively high piezoresistive effect at room temperature when X is 0.25, and the resistivity thereof changes by 7% when strain is applied at 150 MPa. In addition, ceramics such as semiconductor BaTiO₃ exhibits a great piezoresistive effect.

In recent years, the size reduction of chip electronic components including a ceramic body has progressed. However, as the size of the chip electronic component is reduced, the electrical characteristics of the chip electronic component may change before and after reflow mounting. In particular, in the case of a chip electronic component using a semiconductor ceramic, for example, a positive temperature characteristic (PTC) thermistor using semiconductor BaTiO₃ ceramics, the resistance of the chip electronic component may greatly change before and after reflow mounting.

### SUMMARY OF THE INVENTION

Example embodiments of the present invention provide chip electronic components each able to reduce or prevent a significant change in electrical characteristics after the chip electronic components are reflow-mounted.

According to an example embodiment of the present invention, a chip electronic component includes a ceramic body including a semiconductor ceramic including an oxide including Ti and Ba, and a solid metal electrode at an end of the ceramic body and in ohmic contact with the ceramic body. The chip electronic component satisfies the following Formula (1): A/V≥3.3 (mm²/mm³) . . . (1), where A (mm²) is a surface area of the solid metal electrode, and V (mm³) is a volume of the ceramic body. A film stress of the solid metal electrode is about 140 MPa or more.

According to the chip electronic components of example embodiments of the present invention, it is possible to reduce or prevent a change in electrical characteristics before and after reflow mounting.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic sectional view of a chip electronic component according to Example Embodiment 1 of the present invention.

FIG. 2 is an enlarged schematic partial sectional view illustrating an example of the chip electronic component according to Example Embodiment 1 of the present invention.

FIG. 3 is an enlarged schematic partial sectional view illustrating an example of the chip electronic component according to Example Embodiment 1 of the present invention.

### DETAILED DESCRIPTION OF THE EXAMPLE EMBODIMENTS

Example embodiments of the present invention will be described in detail below with reference to the drawings.

In a chip electronic component including a semiconductor ceramic, such as a positive temperature characteristic (PTC) thermistor, the electrical characteristics (for example, resistance) of the chip electronic component before and after reflow mounting may greatly change with size reduction.

As a result of intensive studies on the cause of such a change in resistance, the inventors of example embodiments of the present invention have discovered for the first time that the film stress of the solid metal electrode formed on the surface of the ceramic body of the chip electronic component changes before and after reflow mounting, and this change in film stress causes a change in resistance of the chip electronic component. The inventors of example embodiments of the present invention have further conducted studies, and as a result, discovered a surprising finding that the resistance change rate of an electronic component 10 before and after reflow mounting can be reduce to be low by increasing the film stress of the solid metal electrode to some extent in the electronic component 10 before reflow mounting, thereby completing the present invention.

### Example Embodiment 1

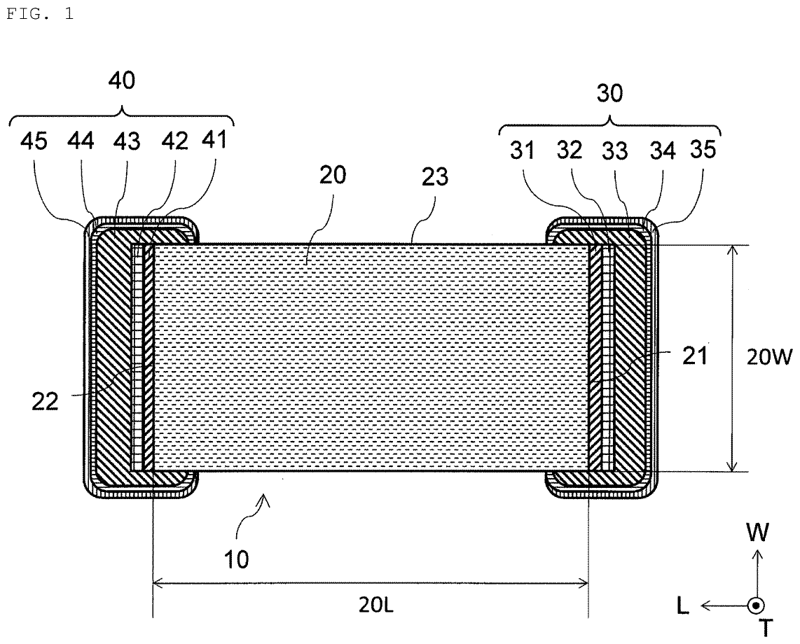

FIG. 1 is a schematic sectional view of the chip electronic component 10 (hereinafter, may be simply referred to as “electronic component 10”) according to Example Embodiment 1 of the present invention.

The electronic component 10 includes a ceramic body 20, and solid metal electrodes 31 and 41 at the ends of the ceramic body 20.

The ceramic body 20 includes a semiconductor ceramic including an oxide including Ti and Ba, for example. The composition of the semiconductor ceramic includes, for example, a perovskite compound including Ba, Ca, Sr, and Ti as main components, and further preferably including R (R is at least one selected from Y, La, Ce, Pr, Nd, Sm, Eu, Gd, Tb, Dy, Ho, Er, Tm, Yb, and Lu), Mn, and Si.

The solid metal electrodes 31 and 41 are in ohmic contact with the ceramic body 20. That is, the solid metal electrodes 31 and 41 are preferably made of a solid metal material that exhibits an ohmic property with the ceramic body 20, and are in direct contact with the surface of the ceramic body 20. Preferred examples of the solid metal material that exhibits an ohmic property with the ceramic body 20 include Cr, a NiCr alloy, Al, and Zn—Ag (ohmic Ag).

The electronic component 10 may further include a protective layer covering the solid metal electrodes 31 and 41. In the example illustrated in FIG. 1, the protective layer preferably includes four layers of conductive solid metal layers 32 and 42, conductive resin layers 33 and 43, first plating layers 34 and 44, and second plating layers 35 and 45. The conductive solid metal layers 32 and 42 are between the solid metal electrodes 31 and 41 and the conductive resin layers 33 and 43, respectively. The conductive resin layers 33 and 43 are between the conductive solid metal layers 32 and 42 and the plating layers (first plating layers 34 and 44 and second plating layers 35 and 45).

The solid metal electrode 31, the conductive solid metal layer 32, the conductive resin layer 33, the first plating layer 34, and the second plating layer 35 can be regarded as defining a first external electrode 30 of the electronic component 10. Similarly, the solid metal electrode 41, the conductive solid metal layer 42, the conductive resin layer 43, the first plating layer 44, and the second plating layer 45 can be regarded as constituting a second external electrode 40 of the electronic component 10.

The electronic component 10 of the present example embodiment satisfies the following Formula (1):

$$A / V \geq 3.3 ( {mm}^{2} / {mm}^{3} ) \qquad ( 1 )$$

where A (mm²) is the surface area of the solid metal electrodes 31 and 41, and V (mm³) is the volume of the ceramic body 20.

Formula (1) represents the ratio of the surface area A (mm²) of the solid metal electrodes 31 and 41 to the volume V (mm³) of the ceramic body 20. The smaller the electronic component 10, the larger the value of A/V. Depending on the formation ranges of the solid metal electrodes 31 and 41, for example, in the case of a chip size 0603 in millimeters, when the solid metal electrodes 31 and 41 are provided only on the end surfaces 21 and 22 on both sides of the ceramic body 20, A/V can be approximately 3.3 mm²/mm³.

Details of the volume V (mm³) of the ceramic body 20 and the surface area A (mm²) of the solid metal electrodes 31 and 41 will be described later.

In the electronic component 10 of the present example embodiment, the film stress of the solid metal electrodes 31 and 41 is, for example, about 140 MPa or more in a state before reflow mounting. As a result, it is possible to reduce or prevent the resistance change rate of the electronic component 10 before and after reflow mounting to be low (for example, less than about 10%).

A mechanism by which the resistance change rate can be reduced or prevented by controlling the film stress of the solid metal electrodes 31 and 41 to be high will be described below.

The solid metal electrodes 31 and 41 in ohmic contact with the ceramic body 20 are in direct contact with the surface of the ceramic body 20. When there is residual stress (film stress) inside the solid metal electrodes 31 and 41, the surface layer portion of the ceramic body 20 receives stress proportional to the magnitude of the film stress.

When the electronic component 10 is reflow-mounted, the film stress of the solid metal electrodes 31 and 41 changes due to the influence of heat at the time of reflow mounting. This change in film stress changes the stress applied to the surface layer portion of the ceramic body 20, and the resistance of the ceramic body 20 changes due to the piezoresistive effect. Although the change in stress applied to the surface layer portion of the ceramic body 20 was minute, this change in stress became apparent due to the size reduction of the electronic component 10, and the change in resistance of the ceramic body 20 became remarkable.

Studies conducted by the inventors of example embodiments of the present invention have revealed that the film stress of the solid metal electrodes 31 and 41 is about 500 MPa at a general reflow temperature (for example, about 130° C. to about 300° C.). The studies have also revealed that when the film stress of the solid metal electrodes 31 and 41 before reflow mounting is close to about 500 MPa, the resistance change rate before and after reflow mounting is small. From this, the inventors have discovered that the resistance change rate before and after reflow mounting can be extremely reduced by increasing the film stress of the solid metal electrodes 31 and 41 in the electronic component 10 before reflow mounting (more specifically, the film stress of the solid metal electrodes 31 and 41 before reflow mounting is made close to the film stress after reflow mounting).

However, the film stress of the solid metal electrodes 31 and 41 also changes by film forming conditions (for example, in the case of sputtering formation, a sputtering temperature, a sputtering time, and the like) of the solid metal electrodes 31 and 41, various processing (for example, barrel polishing), and preliminary heat treatment. Therefore, the inventors have studied in detail the relationship between the resistance change rate allowable for the electronic component 10 and the film stress of the solid metal electrodes 31 and 41 before reflow mounting. As a result, the inventors have discovered that when the film stress of the solid metal electrodes 31 and 41 before reflow mounting is controlled to about 140 MPa or more, for example, the resistance change rate before and after reflow mounting can be suppressed to an allowable range (for example, less than about 10%) in use in general applications.

The film stress of the solid metal electrodes 31 and 41 in the electronic component 10 before reflow mounting can be controlled by adjusting the film forming conditions (for example, in the case of sputtering formation, a sputtering temperature, a sputtering time, and the like) of the solid metal electrodes 31 and 41, the conditions of the processing (for example, barrel polishing) of the electronic component 10 and preliminary heat treatment.

The film stress of the solid metal electrodes 31 and 41 is, for example, preferably about 300 MPa or more, and the resistance change rate before and after reflow mounting can be further reduced.

The film stress of the solid metal electrodes 31 and 41 is, for example, preferably about 490 MPa or less, and occurrence of cracks and peeling in the solid metal electrodes 31 and 41 due to the film stress can be reduced or prevented.

In order to increase the film stress of the solid metal electrodes 31 and 41, it is beneficial to control various manufacturing conditions. Such control of manufacturing conditions may increase the manufacturing cost of the solid metal electrodes 31 and 41, leading to an increase in the manufacturing cost of the electronic component 10. In view of this, the film stress is, for example, more preferably about 400 MPa or less, and an increase in the manufacturing cost of the electronic component 10 can be reduced or prevented.

The film stress of the solid metal electrodes 31 and 41 can be measured by the method described in Examples.

When a protective layer covering the solid metal electrodes 31 and 41 is provided, the protective layer is removed to expose the solid metal electrodes 31 and 41 before measurement of the film stress. The method for removing the protective layer (conductive solid metal layers 32 and 42, conductive resin layers 33 and 43, first plating layers 34 and 44, and second plating layers 35 and 45) is not particularly limited, and examples thereof include physical removal and chemical removal as described below. Physical removal methods include physical etching, a barrel, and the like. The chemical removal method includes a method of dissolving and removing each layer with a solvent that selectively dissolves each layer. In the case of a layer made of a metal material (first plating layers 34 and 44 and second plating layers 35 and 45), the layer can be dissolved with, for example, various acids such as, for example, hydrochloric acid, nitric acid, ferric chloride, ammonium sulfate, hydrogen peroxide, sulfuric acid, boric acid, cyanogen, hydrofluoric acid, and phosphoric acid. In the case of a layer including a resin material (conductive resin layers 32 and 42), the layer can be dissolved to be removed with, for example, various organic solvents such as aromatic solvents, ketones, and ethers.

Next, the volume V (mm³) of the ceramic body 20 and the surface area A (mm²) of the solid metal electrodes 31 and 41 will be described in detail.

Regarding dimensions of the ceramic body 20, the dimension in the W direction is defined as “width 20W” (mm), the dimension in the L direction is defined as “length 20L” (mm), and the dimension in the T direction is defined as “thickness 20T” (mm) (not illustrated). Using each dimension of the ceramic body 20, the volume V of the ceramic body 20 can be determined as follows.

$$Volume V ( {mm}^{3} ) of ceramic body 20 : 20 W \times 20 T \times 20 L$$

The volume V of the ceramic body 20 is preferably about 0.001 mm³ or more and about 0.12 mm³ or less. In such a small-sized ceramic body 20, the advantageous effects of reducing or preventing the resistance change rate by controlling the film stress of the solid metal electrodes 31 and 41 is remarkable.

Using each dimension (width 20W, length 20L, and thickness 20T) of the ceramic body 20, the area of each of the end surfaces 21 and 22 of the ceramic body 20 can be determined as follows.

$$Area ( {mm}^{2} ) of first end surface 21 : 20 W \times 20 T$$

$$Area ( {mm}^{2} ) of second end surface 22 : 20 W \times 20 T$$

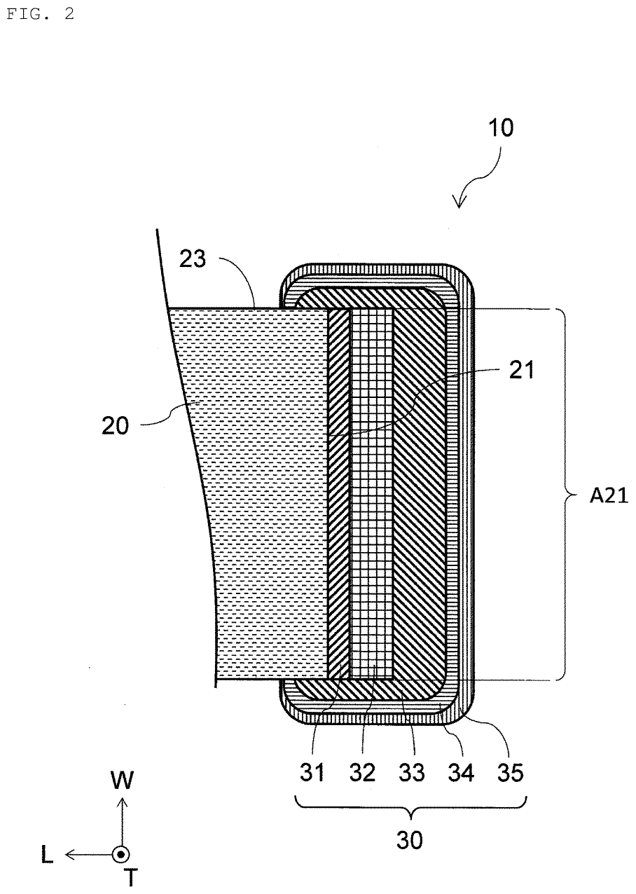

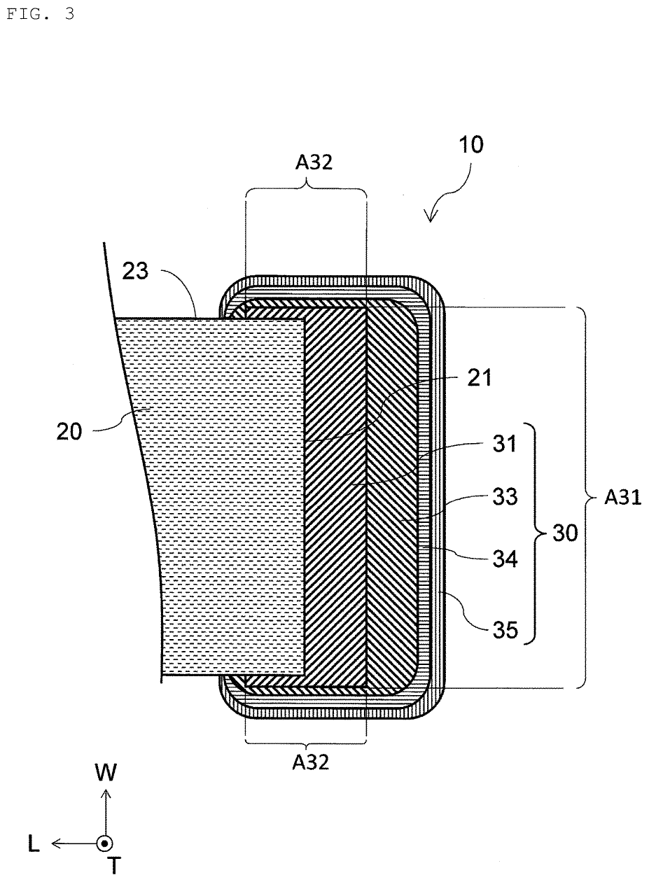

The surface area A of the solid metal electrodes 31 and 41 means the sum of the entire surfaces of the solid metal electrodes 31 and 41. FIGS. 2 and 3 illustrate the solid metal electrodes 31 and 41 having different shapes, and the surface area A of each of the solid metal electrodes 31 and 41 will be described.

FIG. 2 is an enlarged schematic partial sectional view illustrating an enlarged one end (first end surface 21 side) of the ceramic body 20 for the electronic component 10 illustrated in FIG. 1. In FIG. 2, the solid metal electrode 31 covers the first end surface 21 of the ceramic body 20, but does not cover a side surface 23 of the ceramic body 20. In this case, the surface area A21 of the solid metal electrode 31 is equal or substantially equal to the area of the first end surface 21.

Since the area of the first end surface 21 is 20W×20T, the surface area A21 of the solid metal electrode 31 is 20W×20T.

When the solid metal electrode 41 at the other end (second end surface 22 side illustrated in FIG. 1) of the ceramic body 20 is the same as or similar to the solid metal electrode 31 illustrated in FIG. 2 (that is, in the case where the solid metal electrode 41 covers the second end surface 22 of the ceramic body 20, but does not cover the side surface 23 of the ceramic body 20), the surface area of the solid metal electrode 41 is equal or substantially equal to the area of the second end surface 22.

Since the area of the second end surface 22 is 20W×20T, the surface area of the solid metal electrode 41 is 20W×20T.

Since the surface area A of the solid metal electrodes 31 and 41 is the sum of the entire surfaces of the solid metal electrodes 31 and 41, the surface area A can be obtained as (20W×20T)+(20W×20T)=(20W×20T)×2.

FIG. 3 is an enlarged schematic partial sectional view illustrating an enlarged one end (end surface 21 side) of the ceramic body 20 in the electronic component 10 according to another aspect of an example embodiment. In FIG. 3, the solid metal electrode 31 is different from the solid metal electrode 31 illustrated in FIG. 2 in that the solid metal electrode 31 continuously covers not only the first end surface 21 of the ceramic body 20, but also a portion of the side surface 23 of the ceramic body 20 adjacent to the first end surface 21. Although the conductive solid metal layer 32 is not illustrated in FIG. 3, the conductive solid metal layer 32 may be provided to cover only the end surface (surface parallel or substantially parallel to the first end surface 21 of the ceramic body 20) of the solid metal electrode 31, or so as to cover the end surface and the side surface (surface parallel of substantially parallel to the side surface 23 of the ceramic body 20).

In FIG. 3, regarding the surface area of the solid metal electrode 31, the surface area of the surface parallel or substantially parallel to the first end surface 21 of the ceramic body 20 is denoted by A31, and the surface area of the surface substantially parallel to the side surface 23 of the ceramic body 20 is denoted by A32. The surface area of the solid metal electrode 31 is the sum of the surface areas A31 and A32. Although FIG. 3 illustrates the solid metal electrode 31 provided on two surfaces (LT surfaces) of the four side surfaces 23 of the ceramic body 20, the solid metal electrode 31 can also be formed on the remaining two surfaces (LW surfaces) if so desired. In that case, when the surface area of the solid metal electrode 31 is determined, it is necessary to add the surface areas of the solid metal electrode 31 on the LW surfaces.

When the solid metal electrode 41 at the other end (second end surface 22 side illustrated in FIG. 1) of the ceramic body 20 is similar to the solid metal electrode 31 illustrated in FIG. 3 (that is, in the case where the solid metal electrode 41 covers not only the second end surface 22 of the ceramic body 20, but also continuously covers a part of the side surface 23 of the ceramic body 20 adjacent to the second end surface 22), the surface area of the solid metal electrode 41 is the sum of the surface area of the surface parallel of substantially parallel to the second end surface 22 and the surface area of the surface substantially parallel to the side surface 23 of the ceramic body 20, as with the surface area of the solid metal electrode 31 on the first end surface 21 side.

The surface area A of the solid metal electrodes 31 and 41 can be obtained as the sum of the surface area of the solid metal electrode 31 on the first end surface 21 side and the surface area of the solid metal electrode 41 on the second end surface 22.

In the solid metal electrodes 31 and 41 having the shape as illustrated in FIG. 3, the dimensions of the solid metal electrodes 31 and 41 on each side surface are measured with a microscope or the like to calculate the surface area.

### Method for Manufacturing Chip Electronic Component 10

Hereinafter, a method for manufacturing the electronic component 10 according to Example Embodiment 1 will be described by taking a PTC thermistor having a structure illustrated in FIG. 1 as an example.

### Preparation of Ceramic Body 20

The ceramic body 20 preferably includes, for example, a ceramic material obtained by adding a predetermined additive to BaTiO₃ (barium titanate). Examples of the additive include rare earths. The rare earth to be added is typically selected from, for example, Sm, Er, and Y, and may also be selected from Nd, La, and the like.

In the preparation of the ceramic body 20, first, a predetermined amount of a ceramic raw material such as, for example, BaCO₃, TiO₂, PbO, SrCO₃, or CaCO₃ and a rare earth additive (semiconducting agent) are weighed as raw materials of the ceramic body. As the rare earth additive, an oxide of at least one rare earth element selected from Y, La, Ce, Pr, Nd, Sm, Eu, Gd, Tb, Dy, Ho, Er, Tm, Yb, and Lu may be used, for example. In addition to the ceramic raw material and the rare earth additive described above, a characteristic improving agent such as, for example, Mn₂O₃ or a sintering aid such as SiO₂ may be used as a raw material of the ceramic body. Each weighed raw material is charged into a ball mill together with a grinding medium such as, for example, Partially Stabilized Zirconia (PSZ) (hereinafter, also referred to as PSZ ball) and pure water, and wet-mixed and ground. The obtained mixture is calcined at a predetermined temperature (e.g., about 1,000 to about 1,200° C.) to provide a calcined powder.

An organic binder, a dispersant, and pure water are added to the obtained calcined powder, mixed, and then dried to be granulated. A molded body is obtained by molding the obtained granulated product. The molded body is subjected to a degreasing treatment and a debinding treatment, and fired at a predetermined temperature (about 1,200° C. to about 1,400° C.) and in a predetermined atmosphere to obtain a ceramic body 20A.

### Formation of Solid Metal Electrodes 31 and 41

As illustrated in FIGS. 1 to 3, the solid metal electrodes 31 and 41 are preferably formed so as to cover the ends (only the end surfaces 21 and 22 as illustrated in FIGS. 1 and 2, or the end surfaces 21 and 22 and a portion of the side surface 23 as illustrated in FIG. 3) of the ceramic body 20.

The solid metal electrodes 31 and 41 are formed of, for example, metal materials capable of ohmic contact with the ceramic body 20, such as, for example, metal materials such as Zn, Ni, Al, Cr, V, and W, alloys of these metals and Ag, and alloy materials such as NiCr. In particular, solid metal materials such as, for example, Cr, a NiCr alloy, Al, and Zn—Ag (ohmic Ag) are suitable.

The solid metal electrodes 31 and 41 can be formed by a known film forming method. For example, a sputtering method, a vapor deposition method, a coating method (conductive paste is applied to a predetermined position and then baked), a dipping method, or the like can be used.

For example, a sputtering method is suitable for a Cr film, a NiCr alloy film, and an Al film, and a method of performing baking after application is suitable for a Zn—Ag film (ohmic Ag film).

### Formation of Protective Layer

A protective layer may be formed so as to cover the solid metal electrodes 31 and 41.

In Example Embodiment 1, the protective layer preferably includes four layers of the conductive solid metal layers 32 and 42, the conductive resin layers 33 and 43, the first plating layers 34 and 44, and the second plating layers 35 and 45. A method for forming each layer will be described.

### Conductive Solid Metal Layers 32 and 42

The conductive solid metal layers 32 and 42 are preferably formed of a solid metal material having high adhesion to the solid metal electrodes 31 and 41 and high weather resistance. Examples of the solid metal material include metal materials such as Ni, Cr, Au, Ag, and W, and alloy materials such as NiCr, NiCu, and NiV. As the conductive solid metal layers 32 and 42, solid metal material films such as, for example, a NiCu alloy film, a NiV alloy film, and an Ag film are particularly preferable.

The conductive solid metal layers 32 and 42 may be formed of the same material as the solid metal electrodes 31 and 41. For example, when the solid metal material, which exhibits an ohmic property with the ceramic body 20, has characteristics required for the solid metal material for forming the protective layer (conductive solid metal layers 32 and 42), the conductive solid metal layers 32 and 42 and the solid metal electrodes 31 and 41 may be formed of the same material. When these layers are formed of the same material, the solid metal electrodes 31 and 41 and the conductive solid metal layers 32 and 42 can be integrally provided as one layer.

The conductive solid metal layers 32 and 42 are preferably made of a single layer film or a multilayer film, and can be formed by a known film forming method. For example, a sputtering method, a vapor deposition method, a coating method (conductive paste is applied to a predetermined position and then baked), a dipping method, or the like can be used. For example, a sputtering method is suitable for a NiCu alloy film, a NiV alloy film, and an Ag film.

### Formation of Conductive Resin Layers 33 and 43

The conductive resin layers 33 and 43 are preferably provided by curing a resin electrode paste having fluidity. The resin electrode paste contains a conductive powder and a resin raw material. The resin electrode paste is applied to the end of the ceramic body 20 so as to cover the solid metal electrodes 31 and 41, and then the resin raw material in the resin electrode paste is cured.

As the conductive powder included in the resin electrode paste, a powder of metals such as, for example, Ag, Au, Ni, Cu, Pt, Pd, and Al can be used.

As the resin raw material included in the resin electrode paste, for example, a resin raw material such as an epoxy resin, a phenol resin, a urethane resin, a silicone resin, or a polyimide resin can be used.

### Formation of First Plating Layers 34 and 44 and Second Plating Layers 35 and 45

Plating layers (first plating layer 34 and second plating layer 35) are formed so as to cover the surfaces of the conductive resin layers 33 and 43. The plating layer preferably includes a multilayer structure including the first plating layers 34 and 44 in contact with the conductive resin layers 33 and 43, and the second plating layers 35 and 45 covering the first plating layers 34 and 44. In this case, the first plating layers 34 and 44 are formed so as to cover the surfaces of the conductive resin layers 33 and 43, and then the second plating layers 35 and 45 are formed so as to cover the first plating layers 34 and 44.

The first plating layers 34 and 44 can be formed, for example, by the electrolytic plating of at least one of Ni and Cu. The second plating layers 35 and 45 can be formed by, for example, the electrolytic plating of Sn. The first plating layers 34 and 44 and the second plating layers 35 and 45 can be formed by a known plating method, and for example, barrel plating using balls can be used.

As described above, the method for manufacturing the chip electronic component 10 according to Example Embodiment 1 of the present invention has been described by taking the PTC thermistor as an example: however, other chip electronic components can also be appropriately manufactured based on the description of the present specification.

### EXAMPLES

Hereinafter, the present invention will be specifically described with reference to example. However, the present invention is not limited to the examples.

A measurement sample was prepared by the following procedure. It is to be noted that about 5,000 measurement samples can be formed by one preparation.

The film stress of the solid metal electrode in each measurement sample was adjusted so as to be the film stress shown in Table 1 by adjusting the film forming conditions of the solid metal electrode, the conditions of barrel polishing, the conditions of preliminary heat treatment, and the like.

### Examples 1 to 5 and Comparative Examples 2 and 3

The ceramic body 20 was adjusted by grinding and mixing of the raw materials of the ceramic body 20, calcining, molding, firing, and cutting. In the grinding and mixing of the raw materials, BaCO₃, CaCO₃, SrCO₃, PbO, and TiO₂ as main components, Sm₂O₃ as a rare earth element, MnO₂ as a characteristic adjusting material, and SiO₂ as a sintering aid were mixed in a predetermined amount, and then ground and dried. The obtained dry powder was calcined at a maximum temperature of about 1,200° C. in an air atmosphere. An organic binder, a dispersant, and pure water were added to the obtained calcined powder, mixed, and then dried to be granulated. The obtained granulated product was compression-molded. The molded body was subjected to a degreasing treatment and a debinding treatment, and fired at a maximum temperature of about 1,380° C. The fired body was cut into predetermined dimensions to obtain the ceramic body 20.

The solid metal electrodes 31 and 41 (Cr films) and the conductive solid metal layers 32 and 42 (multilayer films of a NiCu alloy film and an Ag film) were formed in this order so as to cover only both end surfaces 21 and 22 of the ceramic body 20. Each film was formed by a sputtering method. CS-S manufactured by ULVAC-PHI, Incorporated was used as a sputtering apparatus, and sputtering was performed under an argon gas flow at an absolute pressure of less than 1 Pa and a sputtering output of 200 W. The film thickness was adjusted by adjusting the sputtering time according to the type of film.

Table 1 shows the type of material of the solid metal electrodes 31 and 41 used in each of Examples and Comparative Examples, and the film thickness of the solid metal electrodes 31 and 41.

### Example 6 and Comparative Example 1

The solid metal electrodes 31 and 41 are preferably formed by a dipping method so as to cover only both end surfaces 21 and 22 of the ceramic body 20 prepared in the same manner as in Example 1. A paste including Ag—Zn was applied to the end surface 21 of the ceramic body 20 by immersing the end surface 21 in the paste, and dried at about 180° C., and then, immersion, application, and drying were similarly performed for the end surface 22, thereby obtaining a dried body having an Ag—Zn film (ohmic Ag film) formed on both end surfaces thereof. The dried body was passed through a belt furnace having a maximum temperature of about 600° C. to bake the solid metal electrodes 31 and 41 on the ceramic body 20. The film thicknesses of the solid metal electrodes 31 and 41 used in Example 6 and Comparative Example 1 are shown in Table 1.

The ceramic substrates 20 used in Examples 1 to 6 and Comparative Examples 1 to 3 had a quadrangular or substantially quadrangular prism shape with the following dimensions (corresponding to 0603 chip).
Length 20L: about 0.60 mm
Width 20W: about 0.28 mm
Thickness 20T: about 0.28 mm

Since the solid metal electrodes 31 and 41 were formed only on both end surfaces 21 and 22 (corresponding to the WT surfaces) of the ceramic body 20, the surface area A (mm²) of the solid metal electrodes 31 and 41 was (20W×20T)×2=(about 0.28 mm×about 0.28 mm)×2=about 0.1568 mm².

The volume V (mm³) of the ceramic body 20 was 20W×20T×20L=about 0.28 mm×about 0.28 mm×about 0.60 mm=about 0.04704 mm³.

From these values, A/V was obtained and described in Table 1.

### Measurement of Film Stress

The film stress of the solid metal electrode was measured using a sin²ψ-2θ method according to X-ray diffraction. This measurement method is excellent in terms of high reproducibility.

As the XRD diffractometer, a micro X-ray diffractometer can be used. In Examples, D8 DISCOVER manufactured by BRUKER axs was used. A CuKα ray was used as an X-ray source.

In each of Examples and Comparative Examples, three samples were randomly selected from about 5,000 measurement samples prepared and subjected to measurement.

The sin²$ method using a micro X-ray diffractometer is a method for measuring a specific diffraction peak to determine the film stress. A method for selecting the specific diffraction peak is performed as follows.

One diffraction peak of “any crystal plane” of a “certain crystal phase” is selected. Since the strain amount is confirmed while tilting the measurement sample, a diffraction peak on a high angle side sensitive to the strain of the crystal phase is desirable. A diffraction peak that does not overlap with the diffraction peaks of other crystal planes and has a clear peak top serving as an index of the spacing (that is, strong intensity) is selected.

In Examples and Comparative Examples, the diffraction lines of Cr (220) for the Cr film, NiCr (222) for the NiCr alloy film, and Ag (222) for the ohmic Ag electrode were measured.

The film stress of the solid metal electrode is determined from the following Formula (2):

$$σ = K \cdot \partial ( 2 θ ) / \partial ( {sin}^{2} ψ ) \qquad ( 2 )$$

where K is a stress constant, and is obtained by the following Formula (3):

$$K = E / ν \qquad ( 3 )$$

where E is the Young's modulus of the material constituting the solid metal electrode, and v is the Poisson's ratio of the material constituting the solid metal electrode.

When the film stress of each of Examples and Comparative Examples was determined, the following values were used as the Young's modulus E and the Poisson's ratio v. These values are known values described in chronological scientific tables, various documents, and the like.

NiCr alloy: E/v=29,400 MPa/0.21

Cr: E/v=82,700 MPa/0.367

Ohmic Ag: E/v=214,000 MPa/0.31

The film stress of the solid metal electrode of the measurement sample was calculated from the result of the micro X-ray diffraction. The average value of the values of the film stress obtained from the three measurement samples is calculated and shown in “Film stress of solid metal electrode” in Table 1.

### Evaluation of Resistance Change Rate

In order to reproduce reflow mounting in a pseudo manner, the measurement sample was placed in a thermostatic chamber at about 230° C. for about 30 minutes. The resistances of the measurement sample before pseudo mounting (before heat treatment) and the measurement sample after pseudo mounting (after heat treatment) were measured. Then, the change rate of the resistance value (resistance change rate) of the resistance value after heating with respect to the resistance value before heating was measured. First, a room-temperature resistance value of the sample before pseudo mounting (before heat treatment) is measured. Then, the sample was mounted on a mounting substrate using a solder paste, and subjected to pseudo mounting (heat treatment). The room-temperature resistance value of the sample after pseudo mounting (after heat treatment) was measured.

A glass epoxy resin substrate (FR-4) was used as a mounting substrate, and Sn-3.0Ag-0.5Cu M705-GRN360-K2KJ-V manufactured by Senju Metal Industry Co., Ltd. was used as a solder paste. As a resistance measuring machine, a commercially available digital multimeter was used. In Examples, a digital multimeter R6451A manufactured by ADVANTEST Corporation was used, but similar measurement results are obtained with other digital multimeters. In the resistance measurement, in the sample before pseudo mounting, the measurement was performed by bringing the digital multimeter into contact with both electrodes (positive electrode and negative electrode) of the sample, and in the sample after pseudo mounting, the measurement was performed by bringing the digital multimeter into contact with the substrate wiring.

Ten samples were randomly selected from about 5,000 prepared measurement samples, and subjected to measurement. The resistance value Ri before mounting and the resistance value Rf after mounting were measured for each sample, and the resistance change rate was determined by the following Formula (4).

Resistance Change Rate (%)=(Rf/Ri−1)×100 (4)

The resistance change rate was determined for each of the 10 measurement samples, and the average value thereof was calculated and shown in “Resistance change rate” in Table 1.

TABLE 1

| | | | | | Before mounting | After pseudo |
|---|---|---|---|---|---|---|
| | | Solid metal electrode | | | Film stress of | mounting |
| | | | | Film | solid metal | Resistance |
| | A/V | | Forming | thickness | electrode | change rate |
| | (mm²/mm³) | Type | method | (μm) | (Mpa) | (%) |
| Example 1 | 3.33 | Ni₇Cr₃ | Sputtering | 0.62 | 488 | <1% |
| | | alloy | | | | |
| Example 2 | 3.33 | Ni₇Cr₃ | Sputtering | 0.62 | 395 | <1% |
| | | alloy | | | | |
| Example 3 | 3.33 | Cr | Sputtering | 0.52 | 376 | 2% |
| Example 4 | 3.33 | Cr | Sputtering | 0.52 | 322 | 4% |
| Example 5 | 3.33 | Ni₇Cr₃ | Sputtering | 0.46 | 271 | 8% |
| | | alloy | | | | |
| Example 6 | 3.33 | Ohmic Ag | Dipping | 29.7 | 143 | 7% |
| Comparative | 3.33 | Ohmic Ag | Dipping | 29.7 | 101 | 10% |
| Example 1 | | | | | | |
| Comparative | 3.33 | Cr | Sputtering | 0.47 | 120 | 12% |
| Example 2 | | | | | | |
| Comparative | 3.33 | Ni₇Cr₃ | Sputtering | 0.11 | 131 | 14% |
| Example 3 | | alloy | | | | |

In Examples 1 to 6 in which the film stress of the solid metal electrode before heat treatment was about 140 MPa or more, the resistance change rate after heat treatment was less than about 10%. On the other hand, in Comparative Examples 1 to 3 in which the film stress of the solid metal electrode before heat treatment was less than about 140 MPa, the resistance change rate after heat treatment was about 10% or more.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A chip electronic component comprising:
a ceramic body including a semiconductor ceramic including an oxide including Ti and Ba; and
a solid metal electrode at an end of the ceramic body and in ohmic contact with the ceramic body; wherein
the chip electronic component satisfies the following Formula:
$$A / V \geq 3.3 ( {mm}^{2} / {mm}^{3} ,$$
where A (mm²) is a surface area of the solid metal electrode, and V (mm³) is a volume of the ceramic body, and
a film stress of the solid metal electrode is about 140 MPa or more.

2. The chip electronic component according to claim 1, wherein the film stress of the solid metal electrode is about 490 MPa or less.

3. The chip electronic component according to claim 1, wherein a volume V of the ceramic body is about 0.001 mm³ or more and about 0.12 mm³ or less.

4. The chip electronic component according to claim 1, wherein the solid metal electrode covers an end surface of the ceramic body.

5. The chip electronic component according to claim 4, wherein the solid metal electrode continuously covers from an end surface of the ceramic body to a portion of a side surface of the ceramic body adjacent to the end surface.

6. The chip electronic component according to claim 1, wherein a composition of the semiconductor ceramic includes a perovskite compound including Ba, Ca, Sr, and Ti as main components, and further includes R (R is at least one selected from Y, La, Ce, Pr, Nd, Sm, Eu, Gd, Tb, Dy, Ho, Er, Tm, Yb, and Lu), Mn, and Si.

7. The chip electronic component according to claim 1, further comprising a protective layer covering the solid metal electrode.

8. The chip electronic component according to claim 7, wherein the protective layer includes conductive solid metal layers, conductive resin layers, first plating layers, and second plating layers.

9. The chip electronic component according to claim 1, further comprising an additional solid metal electrode that is at another end of the ceramic body and is in ohmic contact with the ceramic body.
